(19) United States
(12) Patent Application Publication
(10) Pub. No.: US 2016/0202511 A1
(43) Pub. Date: Jul. 14, 2016

(54) DISPLAY DEVICE

(71) Applicant: Samsung Display Co., Ltd., Yongin-City (KR)

(72) Inventors: Seung Yeon CHAE, Hwaseong-si (KR); Han Su KIM, Seoul (KR); Tae Woon CHA, Seoul (KR)

(21) Appl. No.: 14/711,316

(22) Filed: May 13, 2015

(30) Foreign Application Priority Data
Jan. 8, 2015 (KR) 10-2015-0002964

(51) Int. Cl. G02F 1/1334; G02F 1/1339; G02F 1/1362

(52) U.S. Cl. CPC G02F 1/1334; G02F 1/13624; G02F 1/13394

(57) ABSTRACT

A display device that allows for stable injection of an aligning material or a liquid crystal material is presented. The display device includes: a substrate; thin film transistors disposed on the substrate; pixel electrodes connected to the thin film transistors; a roof layer disposed on the pixel electrodes to be spaced apart from the pixel electrodes with a plurality of microcavities therebetween; a liquid crystal layer disposed in the microcavities; and an encapsulation layer disposed on the roof layer and sealing the microcavities, wherein the roof layer includes ceiling portions covering top surfaces of the microcavities, column portions covering sides of the microcavities, and protruding portions protruding from the column portions.

### CROSS-REFERENCE TO RELATED APPLICATION

This application claims priority to and the benefit of Korean Patent Application No. 10-2015-0002964 filed in the Korean Intellectual Property Office on Jan. 8, 2015, the entire contents of which are incorporated herein by reference.

### BACKGROUND

(a) Technical Field

The present application relates to a display device, and more particularly, to a display device that allows for stable injection of an aligning material or a liquid crystal material.

(b) Description of the Related Art

Liquid crystal displays are one of the most widely used flat panel displays today. Typically, a liquid crystal display includes two display panels on which electric field generating electrodes, such as a pixel electrode and a common electrode, are formed, and a liquid crystal layer formed therebetween. The liquid crystal display generates an electric field in the liquid crystal layer by applying a voltage to the electric field generating electrodes, determines the alignment of liquid crystal molecules of the liquid crystal layer through the generated electric field, and displays an image by controlling the polarization of incident light.

Two display panels constituting the liquid crystal display may include a thin film transistor display panel and an opposing display panel. A gate line to transmit a gate signal and a data line to transmit a data signal may be alternately formed on the thin film transistor display panel to intersect each other. A thin film transistor connected to the gate line and the data line, a pixel electrode connected to the thin film transistor, etc., may he formed on the thin film transistor display panel. A light blocking member, color filters, a common electrode, etc., may be formed on the opposing display panel. In some cases, the light blocking member, the color filters, and the common electrode may also be formed on the thin film transistor display panel.

However, conventional liquid crystal displays are heavy and thick, are expensive, and require a long processing time because two substrates are used and individual components are formed on the two substrates.

The above information disclosed in this Background section is only for enhancement of understanding of the background and therefore it may contain information that does not form the prior art that is already known in this country to a person of ordinary skill in the art,

### SUMMARY

Embodiments have been made in an effort to provide a display device that can reduce width, thickness, cost, and processing time by manufacturing the display device using one substrate.

In addition, embodiments provide a display device that allows for stable injection of an aligning material or a liquid crystal material.

An exemplary embodiment provides a display device including: a substrate; thin film transistors disposed on the substrate; pixel electrodes connected to the thin film transistors; a roof layer disposed on the pixel electrodes to be spaced apart from the pixel electrodes with a plurality of microcavities therebetween; a liquid crystal layer disposed in the microcavities; and an encapsulation layer disposed on the roof layer and sealing the microcavities, wherein the roof layer includes ceiling portions covering top surfaces of the microcavities, column portions covering sides of the microcavities, and protruding portions protruding from the column portions.

The microcavities may be disposed in a matrix, and the display device may further include: first valleys disposed between each pair of microcavities adjacent in a column direction; and second valleys disposed between each pair of microcavities adjacent in a row direction, and the first valleys and the second valleys cross each other.

The column portions may be disposed in the second valleys.

The protruding portions may be disposed in the first valleys.

The protruding portions may protrude from the column portions disposed at the crossings of the first valleys and the second valleys.

At least one protruding portion may be disposed between two microcavities adjacent to each other in a column direction.

Four protruding portions may be disposed between two microcavities adjacent to each other in a column direction.

Two of the four protruding portions may protrude from the column portion disposed on the left side of the two microcavities adjacent to each other in a column direction, and the other two protruding portions may protrude from the column portion disposed on the right side of the two microcavities adjacent to each other in a column direction.

One protruding portion may he disposed between two microcavities adjacent to each other in a column direction.

The one protruding portion may connect two adjacent column portions to each other.

The thickness of the protruding portions may be about 1.0 μm or greater, and may be smaller than the height of the microcavities.

The protruding portions may range from 1.3 μm to3 μm in thickness.

The above-described display device according to an exemplary embodiment has the following features.

A display device according to an exemplary embodiment allows for stable formation of an alignment layer or liquid crystal layer by forming protruding portions near injection holes to prevent excessive flow of an aligning material or a liquid crystal material.

### BRIEF DESCRIPTION OF THE DRAWINGS

FIG. 1 is a top plan view showing a display device according to an exemplary embodiment.

FIG. 2 is equivalent circuit diagram of a pixel of a display device according to an exemplary embodiment.

FIG. 3 is a layout view showing a part of a display device according to an exemplary embodiment.

FIG. 4 is a cross-sectional view of a display device according to an exemplary embodiment taken along line IV-IV of FIG. 3.

FIG. 5 is a cross-sectional view of a display device according to an exemplary embodiment taken along line V-V of FIG. 3.

FIG. 6 is a top plan view of a display device according to an exemplary embodiment.

FIG. 7 is a layout view showing a part of a display device according to an exemplary embodiment.

FIG. 8 is a cross-sectional view of a display device according to an exemplary embodiment taken along line of FIG. 7.

### DETAILED DESCRIPTION OF THE EMBODIMENTS

The inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

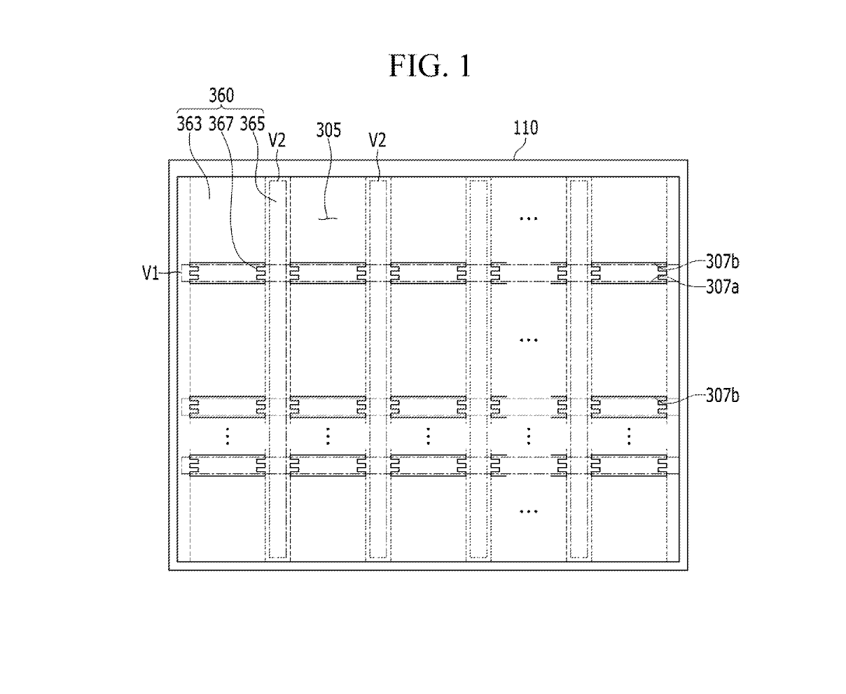

First, a display device according to an exemplary embodiment will be schematically described below with reference to FIG. 1.

FIG. 1 is a top plan view showing a display device according to an exemplary embodiment.

A display device according to an exemplary embodiment includes a substrate 110 made of a material such as glass or plastic.

A plurality of microcavities 305 covered with a roof layer 360 is formed on the substrate 110. The roof layer 360 includes ceiling portions 363 covering the top surfaces of the microcavities 305, column portions 365 covering the sides of the microcavities 305, and protruding portions 367 protruding from the column portions 365.

The microcavities 305 may be disposed in a matrix. First valleys V1 are disposed between each pair of microcavities 305 adjacent in a column direction, and second valleys V2 are disposed between each pair of microcavities 305 adjacent in a row direction.

The column portions 365 of the roof layer 360 are disposed between each pair of microcavities 305 adjacent in a row direction. That is, the column portions 365 are disposed in the second valleys V2. The first valleys V1 and the second valleys V2 cross each other, and the column portions 365 are also formed at the crossings of the first valleys V1 and the second valleys V2. The ceiling portions 363 of the roof layer 360 disposed on different microcavities 305 are connected by the column portions 365. Accordingly, a single roof layer 360 is formed on the substrate 110.

Each first valley V1 has parts where the roof layer 360 is not formed, aid the sides of each microcavity 305 at these parts are not covered with the roof layer 360. That is, some of the sides of each microcavity 305 are covered with the column portion 365 of the roof layer 360, and the other sides are not covered with the roof layer 360. The parts not covered with the roof layer 360 but are exposed externally are referred to as injection holes 307a and 307b.

The injection holes 307a and 307b are formed on two opposite edges of a microcavity 305. The injection holes 307a and 307b include a first injection hole 307a and a second injection hole 307b. The first injection hole 307a is formed to extend to and expose the side of a first edge of the microcavity 305, and the second injection hole 307b is formed to extend to and expose the side of a second edge of the microcavity 305. The sides of the first and second edges of the microcavity 305 face each other.

The roof layer 360 is formed in such a way that it is spaced apart from the substrate 110 between adjacent second valleys V2, thereby forming the microcavity 305. That is, the roof layer 360 is formed to cover the other sides, except the sides of the first and second edges where the injection holes 307a and 307b are formed.

The above-described structure of a display device according to an exemplary embodiment is only an illustration, and may be modified in various ways. For example, the layout of microcavities 305, first valleys V1, and second valleys V2 may be modified, the roof layer 360 may be split apart at the first valleys V1, and part of the roof layer 360 may be spaced apart from the substrate 110 at the second valleys V2 so that adjacent microcavities 305 are connected together.

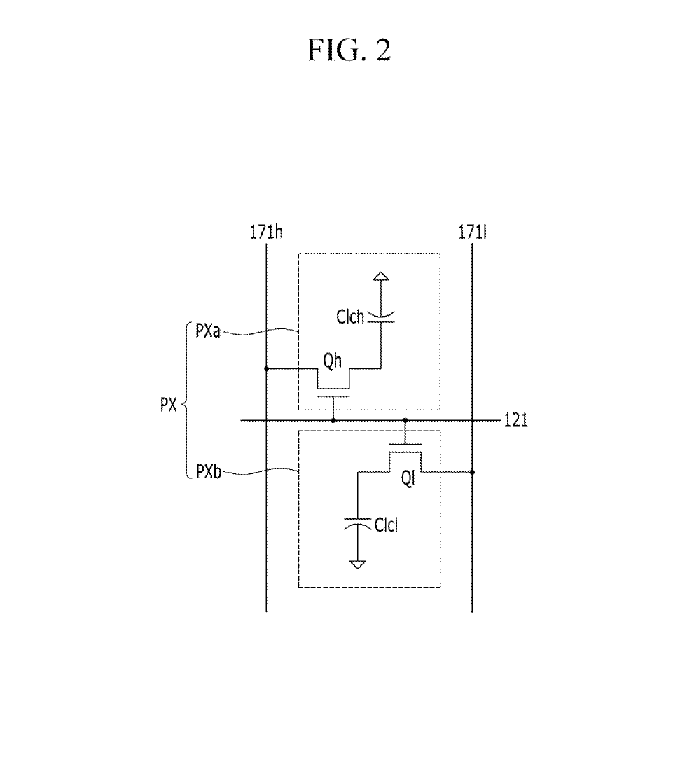

Hereinafter, a pixel of a display device according to an exemplary embodiment will be schematically described with reference to FIG. 2.

FIG. 2 is an equivalent circuit diagram of a pixel PX of a display device according to an exemplary embodiment.

A display device according to an exemplary embodiment includes a plurality of signal lines 121, 171h, and 171l and a pixel PX connected to them. Although not shown, a plurality of pixels PX may be disposed in a matrix including a plurality of pixel rows and a plurality of pixel columns.

Each pixel PX may include a first subpixel PXa and a second subpixel PXb. The first subpixel PXa and the second subpixel PXb may be disposed one above the other. In this instance, a first valley V1 may be disposed along a pixel row between the first subpixel PXa and the second subpixel PXb, and a second valley V2 may be disposed between each of the pixel columns.

The signal lines 121, 171h, and 171l include a gate line 121 for transmitting a gate signal, and a first data line 171h and a second data line 171l for transmitting different data voltages.

A first thin film transistor Qh is formed to be connected to the gate line 121 and the first data line 171h, and a second thin film transistor Q1 is formed to be connected to the gate line 121 and the second data line 171l.

A first liquid crystal capacitor Clch connected to the first thin film transistor Qh is formed in the first subpixel PXa, and a second thin film transistor Clcl connected to the second thin film transistor Q1 is connected to the second subpixel PXb.

A first terminal of the first thin film transistor Qh is connected to the gate line 121, a second terminal thereof is connected to the first data line 171h, and a third terminal thereof is connected to the first liquid crystal capacitor Clcl.

A first terminal of the second thin film transistor Q1 is connected to the gate line 121, a second terminal thereof is connected to the second data line 171l, and a third terminal thereof is connected to the second liquid crystal capacitor Clcl.

As for an operation of a display device according to an exemplary embodiment, when a gate-on voltage is applied to the gate line 121, the first thin film transistor Qh and second thin film transistor Q1 connected to the gate line 121 are turned on, and the first and second liquid crystal capacitors Clch and Clcl are charged with different data voltages transmitted through the first and second data lines 171h and 171l. The data voltage transmitted through the second data line 171l is lower than the data voltage transmitted through the first data line 171h. Accordingly, the second liquid crystal capacitor Clcl is charged with a lower voltage than the first liquid crystal capacitor Clch, thereby improving side visibility.

However, the inventive concept is not limited thereto, and the layout design of thin film transistors for applying different voltages to the two subpixels PXa and PXb can be modified in various ways. Also, a pixel PX may include two or more subpixels, or may consist of a single pixel.

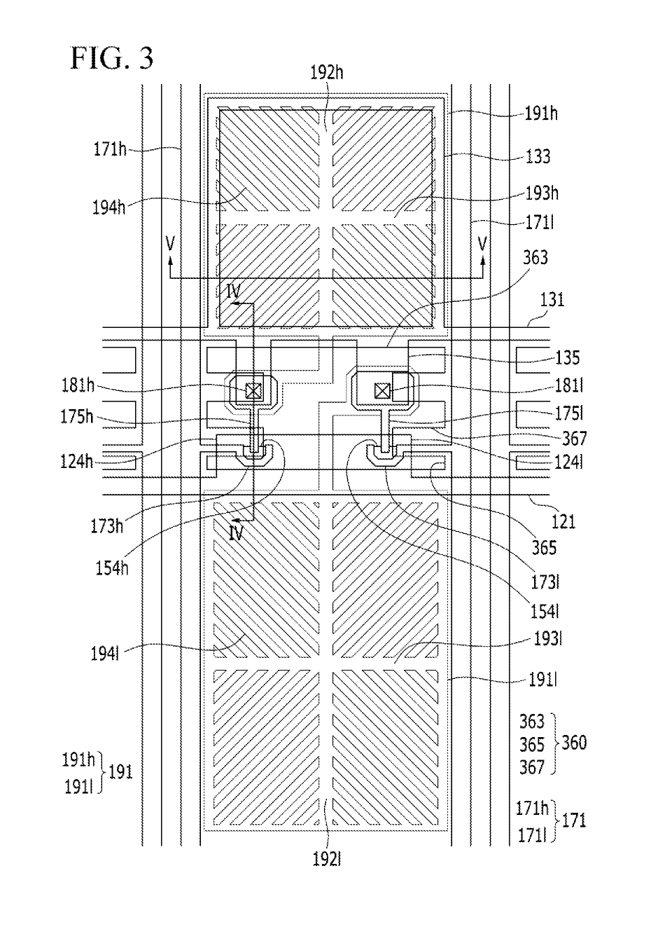

Hereinafter, a structure of one pixel of a display device according to an exemplary embodiment will be described with reference to FIGS. 3 to 5.

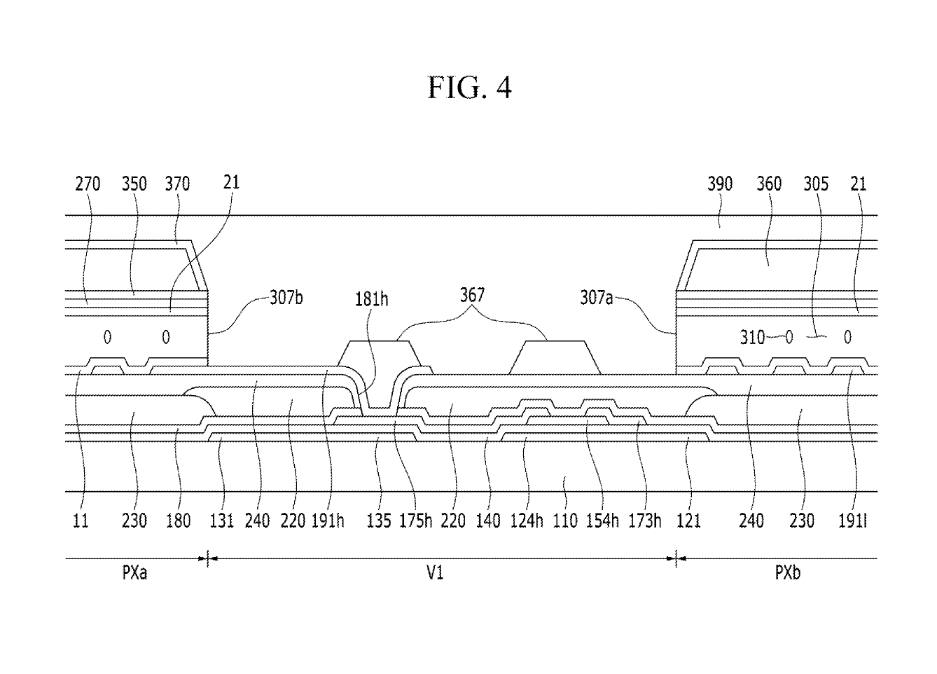

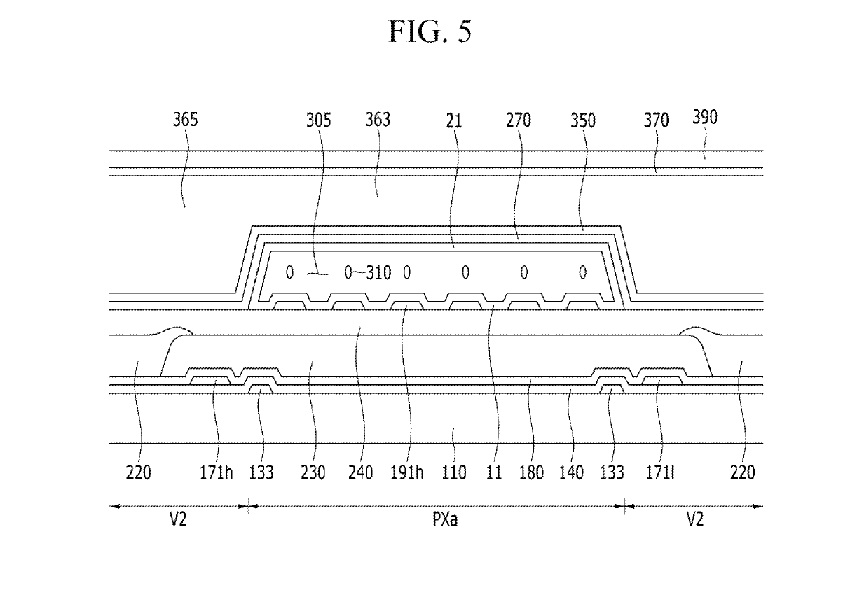

FIG. 3 is a layout view showing a part of a display device according to an exemplary embodiment. FIG. 4 is a cross-sectional view of a display device according to an exemplary embodiment taken along line IV-IV of FIG. 3. FIG. 5 is a cross-sectional view of a display device according to an exemplary embodiment taken along line V-V of FIG. 3.

Referring to FIGS. 3 to 5, a gate line 121 and first and second gate electrodes 124h and 124l protruding from the gate line 121 are formed on a substrate 110.

The gate line 121 extends in a first direction, and transmits a gate signal. The gate line 121 is disposed between two microcavities 305 adjacent to each other in a column direction. That is, the gate line 121 is disposed in a first valley V1. The first gate electrode 124h and the second gate electrode 124l protrude upward from the gate line 121 in a top plan view. The first gate electrode 124h and the second gate electrode 124l may be connected together to form one protruding portion. However, the embodiments are not limited thereto, and the first gate electrode 124h and the second gate electrode 124l may protrude in various shapes.

A storage electrode line 131 and storage electrodes 133 and 135 protruding from the storage electrode line 131 may be further formed on the substrate 110.

The storage electrode line 131 extends in a direction parallel to the gate line 121, and is spaced apart from the gate line 121. A constant voltage may he applied to the storage electrode line 131. The storage electrode 133 protruding upward from the storage electrode line 131 is formed to surround the edges of a first subpixel PXa. The storage electrode 135 protruding downward from the storage electrode line 131 is formed adjacent to the first gate electrode 124h and the second gate electrode 1241.

A gate insulating layer 140 is formed on the gate line 121, the first gate electrode 124h, the second gate electrode 124l, the storage electrode line 131, and the storage electrodes 133 and 135. The gate insulating layer 140 may be made of an inorganic insulating material such as a silicon nitride (SiNx) or a silicon oxide (SiOx). Also, the gate insulating layer 140 may be made up of a single layer or multiple layers.

A first semiconductor 154h and a second semiconductor 154l are formed on the gate insulating layer 140. The first semiconductor 154h may be disposed above the first gate electrode 124h, and the second semiconductor 154l may he disposed above the second gate electrode 124l. The first semiconductor 154h may also be formed under the first data line 171h, and the second semiconductor 154l may also be formed under the second data line 171l. The first semiconductor 154h and the second semiconductor 154l may be made of amorphous silicon, polycrystalline silicon, a metal oxide, and so on.

An ohmic contact member (not shown) may be further formed on each of the first and second semiconductors 154h and 154l. The ohmic contact member may be made of a material such as a silicide or n+ hydrogenated amorphous silicon doped with an n-type impurity at a high concentration.

The first data line 171h, the second data line 171l, a first source electrode 173h, a first drain electrode 175h, a second source electrode 173l, and a second drain electrode 175l are formed on the first semiconductor 154h, the second semiconductor 154l, and the gate insulating layer 140.

The first data line 171h and the second data line 171l, collectively the data lines 171, transmit a data signal, and extend in a second direction and intersect the gate line 121 and the storage electrode line 131. The data lines 171 are disposed between two microcavities 305 adjacent to each other in a row direction. That is, the data lines 171 are disposed in a second valley V2.

The first data line 171h and the second data line 171l transmit different data voltages. For example, the data voltage transmitted through the second data line 171l is lower than the data voltage transmitted through the first data line 171h.

The first source electrode 173h is formed to protrude on the first gate electrode 124h from the first data line 171h, and the second source electrode 173l is formed to protrude on the second gate electrode 124l from the second data line 171l. The first drain electrode 175h and the second drain electrode 175l each include one wide end portion and the other bar-shaped end portion. The wide end portions of the first drain electrode 175h and second drain electrode 175l overlap the storage electrode 135 protruding downward from the storage electrode line 131. The bar-shaped end portions of the first drain electrode 175h and second drain electrode 1751 are partially surrounded by the first source electrode 173h and the second source electrode 173l, respectively.

The first and second gate electrodes 124h and 1241, the first and second source electrodes 173h and 173l, and the first and second drain electrodes 175h and 175l, along with the first and second semiconductors 154h and 154l, constitute first and second thin film transistors (TFTs) Qh and Q1, respectively. In this instance, channels of the thin film transistors Qh and Q1 are formed in the semiconductors 154h and 1541 between the source electrodes 173h and 173l and the drain electrodes 175h and 175l, respectively.

A passivation layer 180 is formed on the first data line 171h, the second data line 171l, the first source electrode 173h, the first drain electrode 175h, the first semiconductor layer 154h exposed between the first source electrode 173h and the first drain electrode 175h, the second source electrode 173l, the second drain electrode 175l, and the second semiconductor layer 1541 exposed between the second source electrode 173l and the second drain electrode 175l. The passivation layer 180 may be made of an organic insulating material or an inorganic insulating material, and may be made of a single layer or multiple layers.

Color filters 230 may be formed in each pixel PX on the passivation layer 180.

Each color filter 230 may display one of primary colors such as red, green, and blue. The color filters 230 are not limited to the three primary colors such as red, green, and blue, and may also display cyan, magenta, yellow, white-based colors, and the like. The color filters 230 may not be formed in the first valley V1 and/or the second valley V2.

A light blocking member 220 is formed in an area between neighboring color filters 230. The light blocking member 220 may be formed on the boundary of the pixel PX and the thin film transistors Qh and Q1, thereby preventing light leakage. That is, the light blocking member 220 may be formed in the first valley V1 and the second valley V2. The light blocking member 220 may be omitted in the second valley V2. The color filters 230 and the light blocking member 220 may overlap each other in some areas.

A first insulating layer 240 may be further formed on the color filters 230 and the light blocking member 220. The first insulating layer 240 may be made of an organic insulating material, and serves to planarize the top surfaces of the color filters 230 and of the light blocking member 220. The first insulating layer 240 may consist of two layers including a layer made of an organic insulating material and a layer made of an inorganic insulating material. The first insulating layer 240 may be omitted in some cases.

A first contact hole 181h extending to and exposing the wide end portion of the first drain electrode 175h and a second contact hole 181l extending to and exposing the wide end portion of the second drain electrode 175l are formed in the passivation layer 180 and the first insulating layer 240.

A pixel electrode 191 is formed on the first insulating layer 240. The pixel electrode 191 may be made of a transparent metal oxide such as indium tin oxide (ITO), indium zinc oxide (IZO), etc.

The pixel electrode 191 includes a first subpixel electrode 191h and a second subpixel electrode 191l that are separated from each other with the gate line 121 and the storage electrode line 131 interposed between them. The first subpixel electrode 191h and the second subpixel electrode 191l are disposed in upper and lower parts of the pixel PX with respect to the gate line 121 and the storage electrode line 131. That is, the first subpixel electrode 191h and the second subpixel electrode 191l are separated from each other with the first valley V1 interposed between them, and the first subpixel electrode 191h is disposed in the first subpixel PXa and the second subpixel electrode 1911 is disposed in a second subpixel PXb.

The first subpixel electrode 191h is connected to the first drain electrode 175h via the first contact hole 181h, and the second subpixel electrode 191l is connected to the second drain electrode 175l via the second contact hole 181l. Accordingly, when the first thin film transistor Qh and the second thin film transistor Q1 are in the on state, the first subpixel electrode 191h and the second subpixel electrode 191l receive different data voltages from the first drain electrode 175h and the second drain electrode 175l, respectively.

The overall shape of the first subpixel electrode 191h and the second subpixel electrode 191l is rectangular, and the first subpixel electrode 191h and the second subpixel electrode 191l each include cross-like stem portions consisting of horizontal stem portions 193h and 193l and vertical stem portions 192h and 192l crossing the horizontal stem portions 193h and 193l, respectively. Further, the first subpixel electrode 191h and the second subpixel electrode 191l each include a plurality of minute branch portions 194h and 194l.

The pixel electrode 191 is divided into four subregions by the horizontal stem portions 193h and 193l and the vertical stern portions 192h and 192l. The minute branch portions 194h and 194l obliquely extend from the horizontal stern portions 193h and 193l and the vertical stem portions 192h and 192l, and the direction of extension may form an angle of approximately 45 degrees or 135 degrees with the gate line 121 or the horizontal stern portions 193h and 193l. Further, directions in which the minute branch portions 194h and 194l of two neighboring subregions extend may be perpendicular to each other.

In the present exemplary embodiment, the first subpixel electrode 191h and the second subpixel electrode 191l may further include outer stem portions surrounding the outer edges of the first subpixel PXa and second subpixel PXb, respectively.

The layout of a pixel, the structure of a thin film transistor, and the shape of a pixel electrode described above are only examples, and the embodiments are not limited thereto and may he modified in various ways.

A common electrode 270 is formed on the pixel electrode 191 in such a manner so as to be spaced apart from the pixel electrode 191 by a certain distance. A microcavity 305 is disposed between the pixel electrode 191 and the common electrode 270. That is, the microcavity 305 is surrounded by the pixel electrode 191 and the common electrode 270. The common electrode 270 is formed in a row direction, and is formed on the microcavity 305 and in the second valleys V2. The common electrode 270 is formed to cover the top surface and sides of the microcavity 305. The breadth and length of the microcavity 305 may vary with the size and resolution of the display device.

However, the embodiments are not limited to thereto, and the common electrode 270 may be formed with an insulating layer interposed between it and the pixel electrode 191. In this instance, the microcavity 305 may be formed on the common electrode 270.

The common electrode 270 may be made of a transparent metal oxide such as indium tin oxide (ITO), indium zinc oxide (IZO), etc. A constant voltage may be applied to the common electrode 270, and an electric field may be formed between the pixel electrode 191 and the common electrode 270.

Alignment layers 11 and 21 are formed on the pixel electrode 191 and under the common electrode 270, respectively.

The alignment layers 11 and 21 include a first alignment layer 11 and a second alignment layer 21. The first alignment layer 11 and the second alignment layer 21 may be vertical alignment layers, and may be made of an alignment material such as polyamic acid, polysiloxane, polyimide, etc. The first and second alignment layers 11 and 21 may be connected to each other at the sidewalls of the edges of the microcavity 305.

The first alignment layer 11 is formed on the pixel electrode 191. The first alignment layer 11 may be formed directly on the first insulating layer 240 that is not covered with the pixel electrode 191.

The second alignment layer 21 is formed under the common electrode 270 so as to face the first alignment layer 11.

A liquid crystal layer made up of liquid crystal molecules 310 is formed within the microcavity 305 disposed between the pixel electrode 191 and the common electrode 270. The liquid crystal molecules 310 have negative dielectric anisotropy, and may stand up in a direction perpendicular to the substrate 110 when no electrical field is applied to them. That is, the liquid crystal molecules 310 may be vertically aligned.

The first subpixel electrode 191h and second subpixel electrode 191l, to which data voltages have been applied, determine the direction of the liquid crystal molecules 310 disposed within the microcavity 305 between the two electrodes 191 and 270 by generating an electric field with the pixel electrode 191 along with the common electrode 270. As such, the luminance of light passing through the liquid crystal layer varies according to the determined direction of the liquid crystal molecules 310.

A second insulating layer 350 may be further formed on the common electrode 270. The second insulating layer 350 may he made of an inorganic insulating material such as a silicon nitride (SiNx) or a silicon oxide (SiOx), or may be omitted as necessary.

A roof layer 360 is formed on the second insulating layer 350. The roof layer 360 may be made of an organic material. The roof layer 360 may be hardened by a hardening process and serve to maintain the shape of the microcavity 305. The roof layer 360 may be formed in such a manner so as to be spaced apart from the pixel electrode 191, with the microcavity 305 interposed between them.

The roof layer 360 includes ceiling portions 363 covering the top surfaces of the microcavities 305, column portions 365 covering the sides of the microcavities 305, and protruding portions 367 protruding from the column portions 365.

The column portions 365 of the roof layer 360 are disposed between each pair of microcavities 305 adjacent in a row direction. That is, the column portions 365 are disposed in the second valleys V2. The first valleys V1 and the second valleys V2 cross each other, and the column portions 365 are also formed at the crossings of the first valleys V1 and the second valleys V2. The ceiling portions 363 of the roof layer 360 disposed on different microcavities 305 are connected by the column portions 365. Accordingly, a single roof layer 360 is formed on the substrate 110.

The protruding portions 367 are disposed in the first valleys V1. The protruding portion 367 protrude from the column portions 365 disposed at the crossings of the first valleys V1 and the second valleys V2. At least one protruding portion 367 is disposed between two microcavities 305 adjacent to each other in a column direction. That is, one protruding portion 367 or a plurality of protruding portions 367 may be disposed between two microcavities 305 adjacent to each other in a column direction. As illustrated in the drawings, for example, four protruding portions 367 may he disposed between two microcavities 305 adjacent to each other in a column direction. In this instance, two of the four protruding portions 367 protrude from the column portion 365 disposed on the left side of the two microcavities 305 adjacent to each other in a column direction. The other two protruding portions 367 protrude from the column portion 365 disposed on the right side of the two microcavities 305 adjacent to each other in a column direction.

The common electrode 270 and the roof layer 360 are formed in such a way so as to not cover some parts of the sides of the edges of the microcavity 305. The parts of the microcavity 305 not covered with the common electrode 270 and the roof layer 360 are referred to as injection holes 307a and 307b. The injection holes 307a and 307b include a first injection hole 307a exposing the side of a first edge of the microcavity 305 and a second injection hole 307b exposing the side of a second edge of the microcavity 305. The first edge and the second edge of adjacent microcavities 305 face each other; for example, in a top plan view, the first edge may be the upper edge of the microcavity 305 and the second edge may be the lower edge of the microcavity 305. Since the microcavity 305 is exposed by the injection holes 307a and 307b in the manufacturing process of a display device, an aligning agent or a liquid crystal material may be injected into the microcavity 305 via the injection holes 307a and 307b.

In a structure where the column portions 365 are not disposed at the crossings of the first valleys V1 and the second valleys V2 and the protruding portions 367 are not formed, the roof layer 360 is separated from the substrate 110, leading to low structural stability. In the present exemplary embodiment, an improvement in structure stability can be achieved by forming the column portions 365 at the crossings of the first valleys V1 and the second valleys V2 as well. The column portions 365 of the roof layer 360 are formed to extend from one edge of the substrate 110 to the other edge. With this structure, the flow path of an aligning material or liquid crystal material that has been dripped into the first valleys V1 is restricted. That is, the horizontal flow path is blocked by the column portions 365 that extend longitudinally, and hence the longitudinal flow path of the aligning material or liquid crystal material becomes longer and the longitudinal flow rate increases. As the aligning material moves farther from the dropping point, it is dried and therefore may appear as a stain. In the present exemplary embodiment, the flow rate of the aligning material or liquid crystal material may be decreased by forming the protruding portions 367 in the first valleys V1. Because the protruding portions 367 play a role as a speed bump disturbing the movement of the aligning material or liquid crystal material. Accordingly, stains can be prevented by keeping the aligning material from moving far from the dripping point.

The thickness of the protruding portions 367 of the roof layer 360 may be about 1.0 μm or greater. The flow rate of the aligning material may he decreased effectively when the protruding portions 367 of the roof layer 360 reach a certain thickness or greater. More preferably, the thickness of the protruding portions 367 of the roof layer 360 may be about 1.3 μm or greater.

The thickness of the protruding portions 367 may be similar to the thickness of the ceiling portions 363 or of the column portions 365.

Also, the protruding portions 367 may made thinner than the ceiling portions 363 or the column portions 365 by using a slit mask or a half-tone mask. The thickness of the protruding portions 367 may be smaller than the height of the microcavity 305. For example, the thickness of the protruding portions 367 may be 3 μm or less.

A third insulating layer 370 may he further formed on the roof layer 360. The third insulating layer 370 may be made of an inorganic insulating material such as a silicon nitride (SiNx) or a silicon oxide (SiOx). The third insulating layer 370 may he formed to cover the top surface and/ or sides of the roof layer 360. The third insulating layer 370 serves to protect the roof layer 360 made of an organic material, and may he omitted in some cases.

An encapsulation layer 390 is formed on the third insulating layer 370. The encapsulation layer 390 is formed to cover the injection holes 307a and 307b that externally expose some parts of the microcavity 305. That is, the encapsulation layer 390 may seal the microcavity 305 so as to keep the liquid crystal molecules 310 formed within the microcavity 305 from leaking out. Since the encapsulation layer 390 is in contact with the liquid crystal molecules 310, the encapsulation layer 390 may be made of a material that does not react with the liquid crystal molecules 310. For example, the encapsulation layer 390 may be made of parylene.

The encapsulation layer 390 may have a multilayer structure such as a double-layer structure or as triple-layer structure. The double-layer structure is made up of two layers made of different materials. The triple-layer structure is made up of three layers, in which adjacent layers are made of different materials. For example.. the encapsulation layer 390 may include a layer made of an organic insulating material and a layer made of an inorganic insulating material.

Although not shown, polarizers may be further formed on the upper and lower surfaces of the display device. The polarizers may consist of a first polarizer and a second polarizer. The first polarizer may be attached onto the lower surface of the substrate 110, and the second polarizer may be attached onto the encapsulation layer 390.

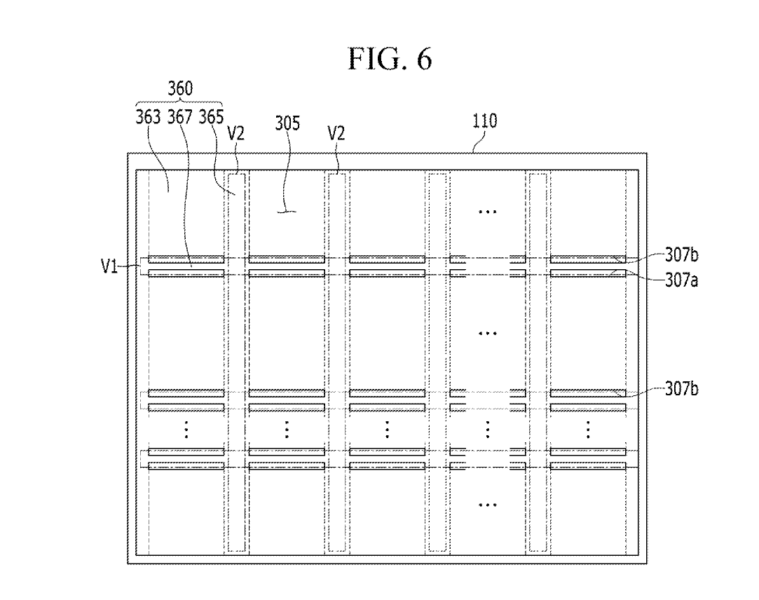

Next, a display device according to an exemplary embodiment will be described below with reference to FIGS. 6 to 8.

Since the display device according to an exemplary embodiment illustrated in FIGS. 6 to 8 is substantially identical to the display device according to an exemplary embodiment illustrated in FIGS. 1 to 5, the overlapping description thereof is omitted. The shape of the protruding portions of a roof layer in the present exemplary embodiment is partially different from that of the foregoing exemplary embodiment, which will be described in more detail below.

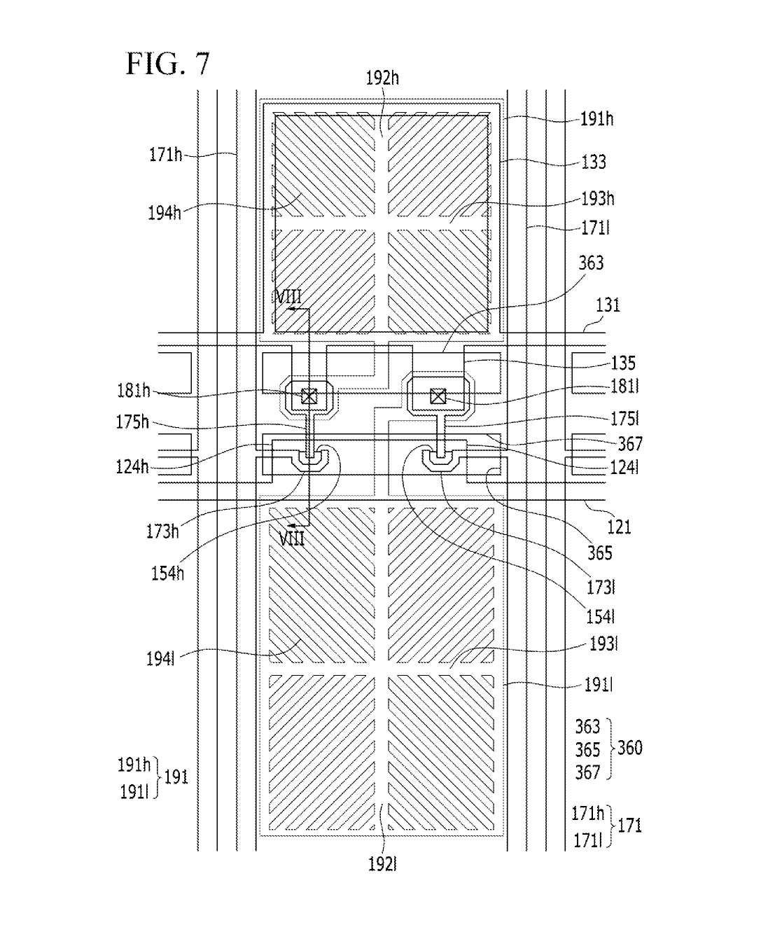

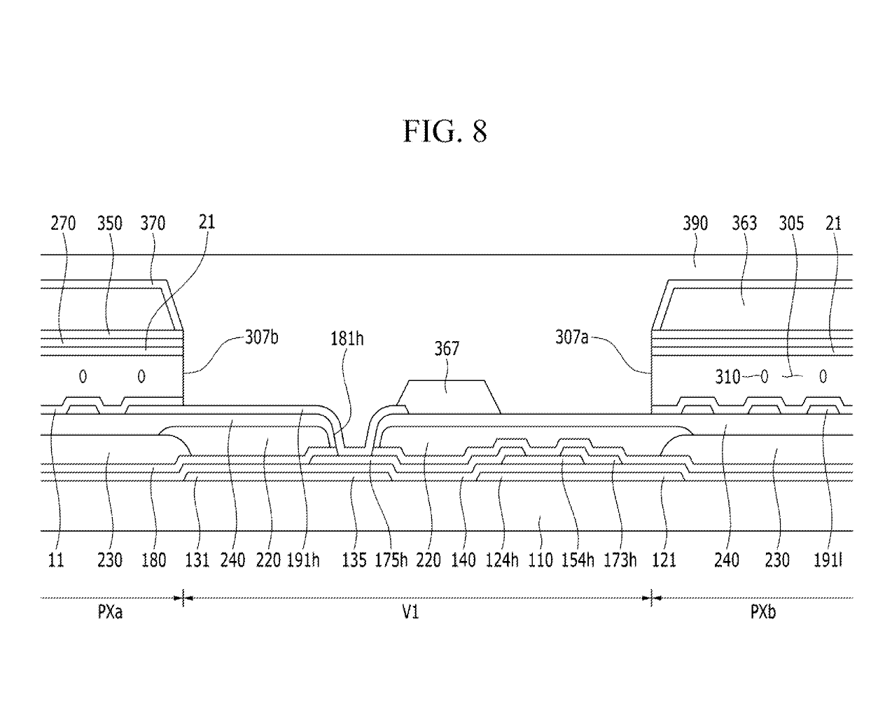

FIG. 6 is a top plan view of a display device according to an exemplary embodiment. FIG. 7 is a layout view showing a part of a display device according to an exemplary embodiment. FIG. 8 is a cross-sectional view of a display device according to an exemplary embodiment taken along line of FIG. 7.

As stated in the foregoing exemplary embodiment, a roof layer 360 is formed on a substrate 110, and microcavities 305 covered with the roof layer 360 are formed on the substrate 110.

The roof layer 360 includes ceiling portions 363 covering the top surfaces of the microcavities 305, column portions 365 covering the sides of the microcavities 305, and protruding portions 367 protruding from the column portions 365.

The protruding portions 367 are disposed in the first valleys V1. The protruding portion 367 protrude from the column portions 365 disposed at the crossings of the first valleys V1 and the second valleys V2. At least one protruding portion 367 is disposed between two microcavities 305 adjacent to each other in a column direction. In the foregoing exemplary embodiment, a plurality of protruding portions 367 are disposed between two microcavities adjacent to each other in a column direction, whereas, in the present exemplary embodiment, one protruding portion 367 is disposed between them.

The protruding portion 367 connects two adjacent column portions 365 to each other. The protruding portions 367 may connect the column portion 365 disposed on the left side of the two microcavities 305 adjacent to each other in a column direction and the column portion 365 disposed on the right side. The protruding portions 367 may be disposed in the middle between the two microcavities 305 adjacent to each other in a column direction.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

### DESCRIPTION OF SYMBOLS

| | | | |
|---|---|---|---|
| 110: | substrate | 121: | gate line |
| 131: | storage electrode line | 171: | data line |
| 191: | pixel electrode | 220: | light blocking member |
| 230: | color filter | 270: | common electrode |
| 305: | microcavity | 307a, 307b: | injection hole |
| 310: | liquid crystal molecule | 360: | roof layer |
| 363: | ceiling portion of roof layer | | |
| 365: | column portion of roof layer | | |
| 367: | protruding portion | | |
| | of roof layer | | |
| 390: | encapsulation layer | | |

What is claimed is:

1. A display device comprising:
a substrate;
thin film transistors disposed on the substrate;
pixel electrodes connected to the thin film transistors;
a roof layer disposed on the pixel electrodes to be spaced apart from the pixel electrodes with a plurality of microcavities therebetween;
a liquid crystal layer disposed in the microcavities; and
an encapsulation layer disposed on the roof layer and sealing the microcavities,
wherein the roof layer comprises:
ceiling portions covering top surfaces of the microcavities,
column portions covering sides of the microcavities, and
protruding portions protruding from the column portions.

2. The display device of claim 1, wherein
the microcavities are disposed in a matrix, and
the display device further comprises first valleys disposed between each pair of microcavities adjacent in a column direction and second valleys disposed between each pair of microcavities adjacent in a row direction, and
the first valleys and the second valleys cross each other.

3. The display device of claim 2, wherein the column portions are disposed in the second valleys.

4. The display device of claim 3, wherein the protruding portions are disposed in the first valleys.

5. The display device of claim 3, wherein the protruding portions protrude from the column portions disposed at the crossings of the first valleys and the second valleys.

6. The display device of claim 1, wherein at least one protruding portion is disposed between two microcavities adjacent to each other in a column direction.

7. The display device of claim 6, wherein four protruding portions are disposed between two microcavities adjacent to each other in a column direction.

8. The display device of claim 7, wherein
two of the four protruding portions protrude from the column portion disposed on the left side of the two microcavities adjacent to each other in a column direction, and
the other two protruding portions protrude from the column portion disposed on the right side of the two microcavities adjacent to each other in a column direction.

9. The display device of claim 1, wherein one protruding portion is disposed between two microcavities adjacent to each other in a column direction.

10. The display device of claim 9, wherein the one protruding portion connects two adjacent column portions to each other.

11. The display device of claim 1, wherein the thickness of the protruding portions is about 1.0 μm or greater, and is smaller than the height of the microcavities.

12. The display device of claim 11, wherein the protruding portions range from 1.3 μm to 3 μm in thickness.
